(19) United States
(12) Patent Application Publication
(10) Pub. No.: US 2025/0297054 A1
(43) Pub. Date: Sep. 25, 2025

(54) BLOCKED POLYISOCYANATES

(71) Applicant: Covestro Deutschland AG, Leverkusen (DE)

(72) Inventors: Hans-Josef Laas, Odenthal (DE); Anne Kutz, Korschenbroich (DE); Bernadette Gerhartz-Quirin, Leverkusen (DE)

(21) Appl. No.: 18/860,819

(22) PCT Filed: May 22, 2023
(86) PCT No.: PCT/EP2023/063673

§ 371 Date: Oct. 28, 2024

(30) Foreign Application Priority Data
May 25, 2022 (EP) 22175418.7

(51) Int. Cl. C08G 18/80; C09D 175/04

(52) U.S. Cl. CPC C08G 18/808; C08G 18/8016; C09D 175/04

(57) ABSTRACT

The invention relates to a method for producing a blocked polyisocyanate, having the steps of reacting A) at least one polyisocyanate component, which has at least isocyanurate and/or iminooxadiazindione structures, with B) at least one branched aliphatic diol and C) at least one secondary amine with aliphatic, cycloaliphatic, and/or araliphatic substituents. The invention is characterized in that the component B) is used in a quantity of more than 2 wt. % based on the total quantity of the components A) and B), the component C) is used in a quantity which corresponds to at least 95 mol. % of the isocyanate groups mathematically still present after the reaction of the components A) and B), and as the polyisocyanate component A), polyisocyanates are used which are produced by modifying simple linear aliphatic, cycloaliphatic, araliphatic, and/or aromatic diisocyanates and which have at least isocyanurate and/or iminooxadiazindione structures, wherein >70 equiv. %, based on the NCO content, is used for the modification process. The invention also relates to said blocked polyisocyanates.

Blocked polyisocyanates, of the kind which may be obtained by reacting isocyanate groups with so-called blocking agents, have been known for a long time. They can be combined with polyols to produce blends that are storage-stable at room temperature. At higher temperatures, the blocking agent is cleaved again and releases the isocyanate group for crosslinking with the polyol component.

Such blocked polyisocyanates serve as crosslinker components for one-component polyurethane (1K-PU) baking enamels and are used, for example, in automotive OEM finishing, plastics painting and coil coating. The type of blocking agent used here is of considerable importance. Reactivity, thermal yellowing and other coating properties are substantially determined by the blocking agent. (U. Meier-Westhues et al. “Polyurethanes: Coatings, Adhesives and Sealants”, 2nd Revised Edition, Hanover: Vincentz Network, 2019).

Secondary monoamines are of particular interest as blocking agents, as they allow particularly low baking temperatures. In particular, the technically and economically important polyisocyanates having isocyanurate groups and based on linear aliphatic diisocyanates, such as 1,6-diisocyanatohexane (hexamethylene diisocyanate, HDI) and 1,5-diisocyanatopentane (pentamethylene diisocyanate, PDI), however, have to date remained without practical significance in a form blocked with secondary amines, such as diisopropylamine. The reason for this is the fact that solutions of such blocked polyisocyanates in the usual paint solvents are not storage-stable for prolonged times, since they show a very high tendency to solidify, e.g., by crystallization of the blocked polyisocyanate present. (D.A. Wicks, Z.W. Wicks Jr, Progress in Organic Coatings 41 (2001) 1-83).

Polyisocyanates, in particular 3-isocyanatomethyl-3,5,5-trimethylcyclohexylisocyanate (IPDI) and toluene diisocyanate (TDI), which are blocked with solely secondary amines optionally after chain extension with diols and/or triols, were described for the first time in EP-A 0 096 210 as crosslinker components for solvent-borne 1K-PU baking enamels. Sterically hindered secondary amines, such as diisopropylamine, dicyclohexylamine or 2,2,6,6-tetramethylpiperidine, are identified as suitable blocking agents. Isocyanurate polyisocyanates are also identified very generally as suitable starting diisocyanates. However, examples using isocyanurate group-containing polyisocyanates of linear aliphatic diisocyanates, which would allow an inference as to the storage stabilities of such products in organic solution, are not found in this publication.

EP-A 0 125 438 also describes 1K binders in which the crosslinking component consists of a reaction product of polyisocyanates, optionally pre-extended with polyols, with solely secondary amines as blocking agents. These binders are used for solvent-borne coating materials, for powder coating, and in their protonated form for cathodic electrodeposition coating as well. However, no information on the storage stability of solutions of the blocked polyisocyanates is found in this publication.

Polyisocyanates, in particular isocyanate-functional prepolymers, which are blocked with secondary amines are known as a crosslinker component for polyamines from EP-A 0 407 829. As suitable starting polyisocyanates for the production of the blocked prepolymers, derivatives of HDI containing biuret or isocyanurate groups are also identified very generally, and may optionally be modified before blocking with a substoichiometric amount of a low molecular weight polyhydroxyl compound. The publication does not allow any conclusions as to the storage stability of polyisocyanates blocked with secondary amines.

EP-A 3 643 733 describes special secondary monoamines carrying both a branched alkyl group with 3 to 6 carbon atoms and a hydrocarbon substituent with 1 or 2 ether groups as blocking agents for isocyanates. Preferred blocking agents of this type are N-(furan-2-ylmethyl)-2-methylpropane-2-amine, 2-methyl-N-((tetrahydrofuran-2-yl) methyl)propane-2-amine, N-(2-methoxyethyl)-2-methylpropane-2-amine, and N-(tert-butyl)-1-methoxypropane-2-amine. The isocyanate groups blocked with these amines are released again at particularly low temperatures. The publication contains neither any information on the lack of crystallization stability of isocyanurate polyisocyanates blocked with secondary amines, nor suggestions on how to overcome this.

The high crystallization tendency of amine-blocked isocyanurate polyisocyanates of linear aliphatic diisocyanates can be reduced in various ways. One concept, for example, is that of so-called mixed blocking, the simultaneous use of two or more different blocking agents.

Blocked polyisocyanates in which the isocyanate groups are blocked to at least 30 equivalent % and to at most 70 equivalent % with diisopropylamine, and to a total of 30 to 70 equivalent % with at least one CH-acidic ester and/or 1.2,4-triazole, are subjects of EP-A 0 600 314. This mixed blocking prevents the crystallization tendency of, for example, derivatives of HDI polyisocyanurate polyisocyanates. However, the different deblocking temperatures of the differently blocked isocyanate groups often lead to problems in practice when using such products in 1K-PU coating systems. In addition, the blocking agent mixtures released during the baking of such systems may also negatively influence the coating properties, which is why polyisocyanates with mixed blocking do not enjoy general utility.

According to the teaching of EP-A 0 900 814, one possibility for the production of crystallization-stable, exclusively amine-blocked polyisocyanate crosslinkers is the reaction of defined mixtures of linear aliphatic and cycloaliphatic polyisocyanates with secondary amines. However, coating films produced using such polyisocyanates have a significantly different property profile and likewise do not enjoy general utility.

According to EP-A 1 524 284, polyisocyanates that are blocked with secondary amines and contain a defined amount of biuret structures are crystallization-stable. Suitable polyisocyanates are pure HDI biurets or else retrospectively biuretized HDI polyisocyanates with isocyanurate and/or iminooxadiazinedione structure. These polyisocyanates may be reacted prior to blocking optionally in proportion with compounds reactive toward isocyanate groups, such as low or higher molecular weight di-or polyfunctional alcohols, amines or higher molecular weight polyhydroxyl compounds based on polyester, polyether, polycarbonate or polyacrylate. In particular, diisopropylamine, N-tert-butylbenzylamine, dicyclohexylamine or mixtures thereof are used as blocking agents.

According to the teaching of WO 2004/104065, polyisocyanates based on linear aliphatic diisocyanates and blocked with secondary amines also behave similarly in terms of crystallization stability when some of the urea groups therein formed in the course of blocking were further converted into biuret structures.

However, polyisocyanates containing biuret structures collectively have a much lower temperature resistance than isocyanurates. Owing to equilibration reactions, which occur in particular under the customary baking conditions in the field of coil coating applications and may possibly lead to the release of monomeric diisocyanates, such products have not been able to assert themselves on the market.

The problem of the lack of crystallization stability and high tendency to solidify of polyisocyanates based on linear aliphatic diisocyanates and containing isocyanurate groups blocked with secondary monoamines has not yet been satisfactorily solved. Despite the high interest in blocked polyisocyanate crosslinkers that crosslink at low baking temperatures, no amine-blocked HDI and/or PDI polyisocyanurate polyisocyanates have to date been available to the user.

As has now been found, surprisingly, polyisocyanurate polyisocyanates based on linear aliphatic diisocyanates, such as HDI or PDI, which have been partially urethanized with branched alcohols, in particular branched diols, can also be reacted with secondary amines, such as diisopropylamine, to give fully solidification-stable, non-crystallizing, blocked polyisocyanate crosslinkers. These new amine-blocked polyisocyanates are particularly suitable for coil coating applications.

A subject of the present invention is a process for producing a blocked polyisocyanate, comprising a reaction of
A) at least one polyisocyanate component which contains at least isocyanurate and/or iminooxadiazinedione structures with
B) at least one branched aliphatic diol and with
C) at least one secondary amine having aliphatic, cycloaliphatic and/or araliphatic substituents,
characterized in that component B) is used in an amount of more than 2% by weight, based on the total amount of components A) and B), and component C) is used in an amount which corresponds to at least 95 mol % of the isocyanate groups arithmetically still present after the reaction of components A) and B), and polyisocyanates produced by modification of simple linear aliphatic, cycloaliphatic, araliphatic and/or aromatic diisocyanates and having at least isocyanurate and/or iminooxadiazinedione structures are used as polyisocyanate component A), where >70 equivalent %, based on the NCO content, of linear aliphatic diisocyanates have been used for the modification.

According to the invention the terms “comprising” or “containing” preferably mean “consisting essentially of” and more preferably mean “consisting of”. The further embodiments recited in the claims and in the description may be combined as desired, provided that the context does not clearly indicate the opposite.

“At least one”, as used herein, refers to 1 or more, for example 2, 3, 4, 5, 6, 7, 8, 9 or more. In connection with constituents of the compounds described herein, this figure refers not to the absolute number of molecules, but rather to the nature of the constituent. “At least one polyisocyanate component” therefore means, for example, that only one kind of polyisocyanate component or two or more different kinds of polyisocyanate components can be present, without specifying the amount of the individual compounds.

Numerical values specified herein without decimal places refer in each case to the full value specified to one decimal place. Thus for example “99%” represents “99.0%”.

Numerical ranges given in the format “in/from x to y” include the values stated. If two or more preferred numerical ranges are given in this format, it is understood that all ranges arising from the combination of the various limits are likewise encompassed.

The term “aliphatic” is presently defined as meaning non-aromatic hydrocarbon groups that are saturated or unsaturated.

The term “linear aliphatic” refers to compounds which are completely free of cyclic structural elements, while the term “alicyclic” or “cycloaliphatic” is defined as optionally substituted, carbocyclic or heterocyclic compounds or units which are not aromatic (such as, for example, cycloalkanes, cycloalkenes or oxa-, thia-, aza-or thiazacycloalkanes). Particular examples are cyclohexyl groups, cyclopentyl groups and their N- or O-heterocyclic derivatives such as for example pyrimidine, pyrazine, tetrahydropyran or tetrahydrofuran.

The term “araliphatic” is presently defined as meaning hydrocarbon radicals consisting of both an aromatic hydrocarbon radical and a saturated or unsaturated hydrocarbon group which is bonded directly to the aromatic radical.

In the event that the groups or compounds are disclosed as “optionally substituted” or “substituted”, suitable substituents are —F, —Cl, —Br, —I, —OH, —OCH₃, —OCH₂CH₃, —O-isopropyl or —O-n-propyl, —OCF₃, —CF₃, —S—C₁₋₆ alkyl and/or (optionally via a pendant heteroatom) a linear or branched, aliphatic and/or alicyclic structural unit having 1 to 12 carbon atoms which in each case functions as a substitute for a carbon-bonded hydrogen atom of the respective molecule. Preferred substituents are halogen (especially —F, —Cl), C₁₋₆ alkoxy (especially methoxy and ethoxy), hydroxyl, trifluoromethyl and trifluoromethoxy which in each case function as a substitute for a carbon-bonded hydrogen atom of the respective molecule. The at least one polyisocyanate component A) which has at least isocyanurate and/or iminooxadiazinedione structures is also referred to in the present invention as starting compound A) or as starting polyisocyanate A) or as polyisocyanate A) or as polyisocyanate A) having isocyanurate and/or iminooxadiazinedione structures. Starting compounds A) for the process according to the invention are any desired polyisocyanates produced by modification of linear aliphatic, cycloaliphatic, araliphatic and/or aromatic diisocyanates and having at least isocyanurate and/or iminooxadiazinedione structures.

Suitable diisocyanates for producing these polyisocyanates A) are any desired diisocyanates, accessible in various ways, for example by phosgenation of the corresponding diamines in the liquid or gas phase or by a phosgene-free route, such as by thermal urethane cleavage, more particularly those diisocyanates of the molecular weight range 140 to 400 with aliphatically, cycloaliphatically, araliphatically and/or aromatically bonded isocyanate groups, such as, for example, 1,4-diisocyanatobutane, 1,5-diisocyanatopentane (pentamethylene diisocyanate, PDI), 1,6-diisocyanatohexane (hexamethylene diisocyanate, HDI), 1,5-diisocyanato-2,2-dimethylpentane, 2,2,4- and 2,4,4-trimethyl-1,6-diisocyanatohexane, 1,8-diisocyanatooctane, 1,9-diisocyanatononane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4 (3)-isocyanatomethylcyclohexane, 2,4′- and 4,4′-diisocyanatodicyclohexylmethane (H₁₂-MDI), 1,3- and 1,4-bis(isocyanatomethyl)cyclohexane, 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane, 1,3-dimethyl-5,7-diisocyanatoadamantane, 1,3- and 1,4-bis-(isocyanatomethyl)benzene (xylylene diisocyanate, XDI), 1,3- and 1,4-bis(1-isocyanato-1-methylethyl)benzene (TMXDI), bis(4-(1-isocyanato-1-methylethyl)phenyl) carbonate, 1,3- and 1,4-phenylene diisocyanate, 2,4-and 2,6-toluene diisocyanate and any mixtures of these isomers, diphenylmethane 2,4′- and/or 4,4′-diisocyanate and naphthylene 1,5-diisocyanate and any mixtures of such diisocyanates. Further diisocyanates that are likewise suitable can also be found for example in Justus Liebigs Annalen der Chemie volume 562 (1949) pp. 75-136.

In another preferred embodiment, polyisocyanates produced by modification of linear aliphatic, cycloaliphatic, araliphatic and/or aromatic diisocyanates and having at least isocyanurate and/or iminooxadiazinedione structures are used as polyisocyanate component A), where >80 equivalent %, particularly preferably >90 equivalent %, based in each case on the NCO content, and especially preferably solely linear aliphatic diisocyanates have been used for the modification.

In another preferred embodiment, polyisocyanates produced by modification of linear aliphatic diisocyanates, preferably 1,6-diisocyanatohexane and/or 1,5-diisocyanatopentane, and having at least isocyanurate and/or iminooxadiazinedione structures are used as polyisocyanate component A).

Preferred diisocyanates for producing the polyisocyanates A) having isocyanurate and/or iminooxadiazinedione structures are those of the stated kind with linear-aliphatically and/or cycloaliphatically bonded isocyanate groups, particularly preferably unbranched linear aliphatic diisocyanates, such as 1,4-diisocyanatobutane, 1,5-diisocyanatopentane, 1,6-diisocyanatohexane, 1,8-diisocyanatooctane, 1,9-diisocyanatononane and 1,10-diisocyanatodecane. Especially preferred diisocyanates are HDI and/or PDI.

Also preferred is a process for producing a blocked polyisocyanate, comprising a reaction of
A) at least one substantially linear aliphatic polyisocyanate component which contains at least isocyanurate and/or iminooxadiazinedione structures with
B) at least one branched aliphatic diol and
C) with at least one secondary amine having aliphatic, cycloaliphatic and/or araliphatic substituents,
characterized in that component B) is used in an amount of more than 2% by weight, based on the total amount of components A) and B), and component C) is used in an amount which corresponds to at least 95 mol % of the isocyanate groups still present arithmetically after the reaction of components A) and B).

According to this preferred embodiment, the polyisocyanate component A) is at least one substantially linear aliphatic polyisocyanate component. In this context, “substantially linear aliphatic” means in particular that the diisocyanates used for the modification are linear aliphatic diisocyanates to an extent of >70 equivalent %, preferably >80 equivalent %, particularly preferably >90 equivalent %, based in each case on the NCO content, and are especially preferably solely linear aliphatic diisocyanates.

The starting polyisocyanates A) having at least isocyanurate and/or iminooxadiazinedione structures for the process according to the invention are produced in a manner known per se by modification, in particular catalytic trimerization, of the stated aliphatic, cycloaliphatic, araliphatic and/or aromatic diisocyanates. Suitable processes are described illustratively, for example, in J. Prakt. Chem. 336 (1994) 185-200, in DE-A 1 954 093, DE-A 2 414 413, DE-A 2 452 532, DE-A 2 641 380, DE-A 3 900 053 and DE-A 3 928 503 or in EP-A 0 336 205, EP-A 0 339 396 and EP-A 0 798 299. Depending on the selected modification process, the polyisocyanates A) used in the process according to the invention may, in addition to isocyanurate and/or iminooxadiazinedione structures, optionally also have uretdione, allophanate, biuret, urethane and/or oxadiazinetrione structures.

In the production of the starting polyisocyanates A), the actual modification reaction is usually followed by a further process step for the separation of the unreacted excess monomeric diisocyanates. This monomer separation is carried out according to processes known per se, preferably by thin-film distillation under reduced pressure or by extraction with suitable solvents inert toward isocyanate groups, for example aliphatic or cycloaliphatic hydrocarbons such as pentane, hexane, heptane, cyclopentane or cyclohexane.

In the process according to the invention, preference is given to using as starting polyisocyanates A) polyisocyanates of the stated type that have a content of monomeric diisocyanates of less than 5% by weight, preferably less than 0.5% by weight, particularly preferably of less than 0.3% by weight. The residual monomer contents are determined in accordance with DIN EN ISO 10283:2007-11 by gas chromatography using an internal standard.

The polyisocyanates A) mentioned above as suitable, preferred, particularly preferred and especially preferred preferably comprise isocyanurate structures and have an average NCO functionality of 2.3 to 5.0, preferably of 2.5 to 4.5, and a content of isocyanate groups of 6.0 to 26.0% by weight, preferably 8.0 to 25.0% by weight, particularly preferably 10.0 to 24.0% by weight.

In the process according to the invention, the polyisocyanate component A) which contains at least isocyanurate and/or iminooxadiazinedione structures is reacted with at least one branched aliphatic diol B).

These are any saturated or unsaturated aliphatic diols, which may be singly or multiply branched, may optionally have heteroatoms, ester groups and/or carbonate groups in the chain, and may optionally be further substituted.

In another preferred embodiment, the at least one branched aliphatic diol has 3 to 36 carbon atoms. Stated by way of example are simple diols, such as 1,2-propanediol, 1,3-butanediol, 2-methyl-1,3-propanediol, 2,2-dimethyl-1,3-propanediol (neopentyl glycol), 2,2-dibutyl-1,3-propanediol, 2,2-dimethyl-1,3-butanediol, 1,2-hexanediol, 2-methyl-2,4-pentanediol, 3-methyl-2,4-pentanediol, 2-methyl-1,5-pentanediol, 3-methyl-1,5-pentanediol, 2-methyl-2-propyl-1,3-propanediol, 2,2-dimethyl-1,3-hexanediol, 2-ethyl-1,3-hexanediol, 1,2-octanediol, 2,2,4-trimethyl-1,3-pentanediol, 2,2,4-trimethyl-1,5-pentanediol, 2-butyl-2-ethyl-1,3-propanediol, 2,2,4- and/or 2,4,4-trimethylhexanediol, 2,2-dibutyl-1,3-propanediol, 1,2-decanediol, 2-(2-methyl) butyl-2-propyl-1,3-propanediol, 2,4-dimethyl-2-propylheptane-1,3-diol and 9-octadecene-1,12-diol, dimer diols, such as are obtainable in a manner known per se, for example by hydrogenation of dimeric fatty acids and/or their esters and available commercially under the names Pripol® 2030, Pripol® 2033 (Croda International Plc, UK) and Sovermol 908 (BASF SE, DE), for example, and ether diols, such as dipropylene glycol, tripropylene glycol and ethylhexylglycerol, ester diols, such as 3-hydroxy-2,2-dimethylpropyl 3-hydroxy-2,2-dimethylpropionate (hydroxypivalyl hydroxypivalate, HPN), glycerol monocaprylate and glycerol monostearate, or any mixtures of such alcohols.

In another preferred embodiment, the at least one branched aliphatic diol has 4 to 12 carbon atoms. Especially preferred are 2-methyl-1,3-propanediol, 2,2-dimethyl-1,3-propanediol, 2-butyl-2-ethyl-1,3-propanediol (BEPD), 2,2-dibutyl-1,3-propanediol, 2,2,4-trimethyl-1,5-pentanediol and 2,2,4- and/or 2,4,4-trimethylhexanediol or any mixtures of such alcohols.

The branched aliphatic diols B) are used in the process according to the invention in an amount of more than 2% by weight, preferably of 3% to 20% by weight, particularly preferably of 4% to 15% by weight and especially preferably of 5% to 12% by weight, based on the total amount of components A) and B). Amounts less than 2% by weight are not sufficient to durably prevent the crystallization of the blocked polyisocyanate; the use of more than 20% by weight can lead to products of very high viscosity which are not economical in practical use, owing to their low isocyanate content.

In addition to the branched aliphatic diols stated, component B) may optionally contain further alcoholic compounds in a subordinate amount.

These are, for example, monoalcohols, such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols, hydroxymethylcyclohexane, 3-methyl-3-hydroxymethyloxetane, benzyl alcohol, phenol, the isomeric cresols, octylphenols, nonylphenols and naphthols, furfuryl alcohol and tetrahydrofurfuryl alcohol, unbranched aliphatic diols, such as 1,2-ethanediol, 1,3-propanediol, 1,4-butanediol, 1,5-pentanediol, 1,6-hexanediol, 1,7-heptanediol and 1,8-octanediol, cycloaliphatic diols, such as 1,2- and 1,4-cyclohexanediol, 1,4-cyclohexanedimethanol, 4,4′-(1-methylidene) biscyclohexanol, triols such as 1,2,3-propanetriol, 1,1,1-trimethylolethane, 1,2,6-hexanediol, 1,1,1-trimethylolpropane, and 1,3,5-tris(2-hydroxyethyl)isocyanurate, tetrafunctional alcohols, such as 2,2-bis(hydroxymethyl)-1,3-propanediol or any mixtures of such alcohols.

If at all, these further alcoholic compounds are used in the process of the invention in amounts of not more than 25% by weight, preferably not more than 20% by weight, particularly preferably 15% by weight, based on the amount of branched aliphatic diols used.

This means that the average OH functionality of component B) is preferably from 1.6 to 2.4, particularly preferably from 1.8 to 2.2, especially preferably 1.9 to 2.1 and in particular 2.0.

In the process according to the invention, at least one secondary amine having aliphatic, cycloaliphatic and/or araliphatic substituents is used as blocking agent C).

These are, in particular, secondary amines of the general formula (I)

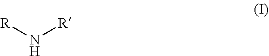

in which R and R′ independently of each other are identical or different radicals which denote saturated or unsaturated, linear or branched, aliphatic, cycloaliphatic or araliphatic organic radicals having 1 to 18 carbon atoms, which are substituted or unsubstituted and/or have oxygen atoms in the chain, where R and R′ also in combination with each other, together with the nitrogen atom and optionally with further oxygen atoms, can form heterocyclic rings having 5 to 8 ring members, which may optionally be further substituted.

Preferably, the radicals R and R′ are saturated linear or branched, aliphatic radicals having 1 to 18, particularly preferably 1 to 6 carbon atoms or cycloaliphatic hydrocarbon radicals having 6 to 13, particularly preferably 6 to 9 carbon atoms, where R and R′ optionally also in combination with each other, together with the nitrogen atom and optionally with a further oxygen atom, can form heterocyclic rings having 5 to 6 ring members, which may optionally be further substituted.

Suitable secondary amines C) for the process according to the invention are, for example, dimethylamine, diethylamine, di-n-propylamine, diisopropylamine, di-n-butylamine, diisobutylamine, di-n-pentylamine, di-n-hexylamine, N-methyl-n-propylamine, N-methyl-n-hexylamine, N-methylstearylamine, N-ethyl-n-propylamine, N-ethylcyclohexylamine, N-isopropyl-tert-butylamine, N-isopropylcyclohexylamine, dicyclohexylamine, di(3,5,5-trimethylcyclohexyl)amine, N-tert-butylbenzylamine, dibenzylamine, piperidine, 2,6-dimethylpiperidine, 2,2,6,6-tetramethylpiperidine, 2,2,4,6-tetramethylpiperidine, hexahydroazepine, pyrrolidine, 2,5-dimethylpyrrolidine or morpholine.

Also suitable, although less preferred, secondary amines C) are those which, in addition to a secondary amino group, carry other groups reactive toward isocyanate groups, but which, like hydroxyl groups, for example, have a lower reactivity toward isocyanate groups than secondary amino groups. Examples of such secondary amines are amino alcohols, such as diethanolamine and diisopropanolamine.

Preferred as secondary amines C) are diisopropylamine, dicyclohexylamine, N-tert-butylbenzylamine or any mixtures of these amines. Diisopropylamine is particularly preferred.

The secondary amines C) are used in the process of the invention in an amount which corresponds to at least 95 mol %, preferably at least 96 mol %, particularly preferably at least 98 mol % and especially preferably at least 100 mol % of the isocyanate groups arithmetically still present after the reaction of components A) and B).

The process according to the invention can optionally also be used in suitable solvents relative to isocyanate groups. Suitable solvents are, for example, the usual paint solvents known per se, such as ethyl acetate, butyl acetate, ethylene glycol monomethyl or monoethyl ether acetate, 1-methoxyprop-2-yl acetate (MPA), 3-methoxy-n-butyl acetate, acetone, 2-butanone, 4-methyl-2-pentanone, cyclohexanone, toluene, xylene, chlorobenzene, white spirit, more highly substituted aromatics, such as those marketed under the names Solvent naphtha, Solvesso®, Isopar®, Nappar® (Deutsche EXXON CHEMICAL GmbH, Cologne, DE) and Shellsol® (Deutsche Shell Chemie GmbH, Eschborn, DE), for example, but also solvents such as propylene glycol diacetate, diethylene glycol dimethyl ether, dipropylene glycol dimethyl ether, diethylene glycol ethyl and butyl ether acetate, N-methylpyrrolidone, N-ethylpyrrolidone, N-butylpyrrolidone and N-methylcaprolactam, or any mixtures of such solvents.

For the implementation of the process according to the invention, the polyisocyanate component A) is reacted with the diol component B) and the amine component C) optionally under inert gas, such as nitrogen, for example, and optionally in the presence of a suitable solvent of the stated type at a temperature between 0 and 120° C., preferably 20 to 100° C., particularly preferably 40 to 80° C. in any order in the above-stated proportions.

The course of the reaction can be followed in the process of the invention, for example by titrimetric determination of the NCO content, preferably according to DIN EN ISO 11909:2007-05.

The reaction of the polyisocyanate component A) with the diol component B) and the amine component C) can take place uncatalyzed in the process according to the invention, but for reaction acceleration the usual urethanization catalysts known from polyurethane chemistry can also be used, for example tertiary amines such as triethylamine, pyridine, methylpyridine, benzyldimethylamine, N,N-endoethylenepiperazine, N-methylpiperidine, pentamethyldiethylenetriamine, N,N-dimethylaminocyclohexane, N,N′-dimethylpiperazine or metal salts such as iron(III) chloride, zinc chloride, zinc octoate, zinc 2-ethylcaproate, zinc acetylacetonate, tin(II) octoate, tin(II) ethylcaproate, tin(II) palmitate, dibutyltin(IV) dilaurate, zirconium(IV) 2-ethyl-1-hexanoate, zirconium(IV) neodecanoate, zirconium(IV) naphthenate, zirconium(IV) acetylacetonate, aluminum tri(ethyl acetoacetate), bismuth(III) 2-ethylhexanoate, bismuth(III) octoate, bismuth(III) neodecanoate and molybdenum glycolate.

These catalysts are used optionally in amounts of 0.001% to 2.0% by weight, preferably 0.01% to 0.2% by weight, based on the total amount of the starting components A), B) and C) used.

If catalysts for reaction acceleration are also used, they can optionally be deactivated, preferably chemically, after the desired NCO content has been reached. Catalyst poisons suitable for this purpose are, for example, inorganic acids such as hydrochloric acid, phosphorous acid or phosphoric acid, acid chlorides such as acetyl chloride, benzoyl chloride or isophthaloyl dichloride, sulfonic acids and sulfonic acid esters such as methanesulfonic acid, p-toluenesulfonic acid, trifluoromethanesulfonic acid, perfluorobutanesulfonic acid, p-toluenesulfonic acid methyl ester and ethyl ester, mono- and dialkyl phosphates such as monotridecyl phosphate, dibutyl phosphate and dioctyl phosphate, but also silylated acids, such as methanesulfonic acid trimethylsilyl ester, trifluoromethanesulfonic acid trimethylsilyl ester, phosphoric acid tris (trimethylsilyl ester) and phosphoric acid diethyl ester trimethylsilyl ester.

The amount of the catalyst poison optionally required for deactivation depends on the amount of the catalyst used. If at all, 0.1 to 2.0, preferably 0.4 to 1.6, particularly preferably 0.8 to 1.2 equivalents and especially preferably an equivalent amount of the stopper, based on the amount of catalyst used, are used.

After the reaction of the polyisocyanate component A) with the diol component B) and the amine component C), preferably if the content of free isocyanate groups is less than 1.0% by weight, preferably less than 0.8% by weight, particularly preferably less than 0.3% by weight, the blocked polyisocyanates can optionally be diluted further with solvent, for example to reduce the viscosity. In addition to the above-mentioned solvents, alcoholic solvents, such as n-butanol or isobutyl alcohol, can also be used here, since the isocyanate groups have then very largely, preferably completely, been consumed by reaction with the blocking agent.

In the process according to the invention, further auxiliaries and adjuvants, such as antioxidants or light stabilizers, for example, may optionally be used as well. These can on the one hand be admixed to one or more of the reaction partners A), B) and C) before the actual reaction begins. However, they can also be added at any time during the reaction to the reaction mixture or after the reaction to the blocked polyisocyanates of the invention.

Suitable antioxidants are, for example, phenols, in particular sterically hindered phenols, such as 2,6-di-tert-butylphenol, 2,4-dimethyl-6-tert-butylphenol, 2,6-di-tert-butyl-4-methylphenol, triethylene glycol bis(3-tert-butyl-4-hydroxy-5-methylphenyl)propionate, octadecyl 3-(3,5-di-tert-butyl-4-hydroxyphenyl)propionate, pentaerythritol tetrakis(3-(3,5-di-tert-butyl-4-hydroxy-phenyl)propionate), esters of 3-(3,5-di-tert-butyl-4-hydroxyphenyl)propionic acid with aliphatic branched C7 to C9 alcohols, such as isoheptyl 3-(3,5-di-tert-butyl-4-hydroxyphenyl)propionate, isooctyl 3-(3,5-di-tert-butyl-4-hydroxyphenyl)propionate or isononyl 3-(3,5-di-tert-butyl-4-hydroxyphenylpropionate, isotridecyl 3-(3,5-di-tert-butyl-4-hydroxyphenyl)propionate, thiodiethyl bis[3-(3,5-di-tert-butyl-4-hydroxyphenyl)propionate], N,N′-hexamethylenebis(3,5-di-tert-butyl-4-hydroxyphenyl)propionamide, 1,2-bis(3,5-di-tert-butyl-4-hydroxyphenylpropionyl)hydrazide, 2,4-di-tert-butylphenyl 4′-hydroxy-3′,5′-di-tert-butylbenzoate, esters of (3,5-di-tert-butyl-4-hydroxyphenyl)methylthioacetic acid with aliphatic branched C10 to C14 alcohols, 2,2′-thiobis(4-methyl-6-tert-butylphenol), 2-methyl-4,6-bis(octylthiomethyl)phenol, 1,3,5-trimethyl-2,4,6-tris(3,5-di-tert-butyl-4-hydroxybenzyl)benzene, tris(3,5-di-tert-butyl-4-hydroxybenzyl)isocyanurate or 2,5-di-tert-amylhydroquinone.

Suitable antioxidants are also thioethers, such as didodecyl 3,3′-thiodipropionate or dioctadecyl 3,3′-thiodipropionate, which are preferably used in combination with phenolic antioxidants of the stated type.

Other suitable antioxidants are phosphites, for example di- or preferably trisubstituted phosphites, such as dibutyl phosphite, dibenzyl phosphite, triethyl phosphite, tributyl phosphite, triisodecyl phosphite, trilauryl phosphite, tris(tridecyl) phosphite, triphenyl phosphite, tris(2,4-di-tert-butylphenyl) phosphite, tris(nonylphenyl) phosphite, diphenyl isooctyl phosphite, diphenyl isodecyl phosphite, diisodecyl phenyl phosphite, diisooctyl octylphenyl phosphite, phenyl neopentyl glycol phosphite, 2,4,6-tri-tert-butylphenyl 2-butyl-2-ethyl-1,3-propanediol phosphite, diisodecyl pentaerythritol diphosphite, distearyl pentaerythritol diphosphite, bis(2,4-di-tert-butylphenyl) pentaerythritol diphosphite or tetraphenyl dipropylene glycol diphosphite.

Suitable light stabilizers are, for example, UV absorbers of the 2-hydroxyphenylbenzotriazole type, those of the type of the HALS compounds substituted or unsubstituted on the nitrogen atom, such as Tinuvin® 292 or Tinuvin® 770 DF (BASF SE, Ludwigshafen, DE), or those as they are described for example in “Lichtschutzmittel für Lacke” (A. Valet, Vincentz Verlag, Hanover, 1996 and “Stabilization of Polymer Materials” (H. Zweifel, Springer Verlag, Berlin, 1997, Appendix 3, pp. 181-213).

Further auxiliaries and adjuvants, which may optionally be used as well in the process according to the invention, are also the hydrazide group-containing and/or hydroxy-functional stabilizers described in EP-A 0 829 500, such as the addition product of hydrazine and propylene carbonate, for example.

The stated auxiliaries and adjuvants can be used in the process according to the invention optionally individually or else in any combinations with one another in amounts of 0.001% to 3.0% by weight, preferably 0.002% to 2.0% by weight, particularly preferably of 0.005% to 1.0% by weight, based in each case on the total amount of starting polyisocyanate A).

Irrespective of the nature of the process regime, the process according to the invention affords completely clear and transparent polyisocyanates blocked with secondary monoamines and containing isocyanurate groups, or organic solutions of such polyisocyanates, which, in contrast to comparable polyisocyanates produced using the same starting components but without partial urethanization with branched alcohols, have no tendency to crystallize, even when stored at low temperatures for relatively long, for example at 15 to 25° C. over a time of 12 weeks.

Another subject of the invention, therefore, is the blocked polyisocyanate obtainable or obtained by the process according to the invention.

Another subject of the invention is the use of more than 2% by weight of at least one branched aliphatic diol B), based on the total amount of components A) and B), for stabilizing aliphatic polyisocyanates blocked with at least one secondary amine C).

The blocked polyisocyanates according to the invention are valuable starting materials for the production of polyurethane plastics by the isocyanate polyaddition process. They are outstandingly suited as crosslinker components for one-component heat-curing solvent-borne or aqueous coating systems, which are used in particular in plastics painting, in automotive OEM finishing or for coil coating applications. They provide coatings that show a very good resistance to yellowing even under overbake conditions.

A further subject of the invention are therefore one-component baking systems, comprising
a) at least one blocked polyisocyanate according to the invention,
b) at least one binder reactive toward isocyanate groups and having on average at least two isocyanate-reactive groups per molecule,
c) optionally catalysts, and
d) optionally solvents and/or optionally auxiliaries and adjuvants.

Finally, substrates at least partially coated with at least one cured one-component baking system according to the invention are also another subject of the invention.

For the production of the one-component baking systems (1K baking varnishes) according to the invention, the blocked polyisocyanates a) according to the invention are mixed with coatings binders b) known per se from coatings technology, optionally with accompanying use of catalysts c) accelerating the crosslinking reaction, and optionally solvents and/or optionally auxiliaries and adjuvants d). This mixing must be carried out below the temperature at which the blocking agent is cleaved off, as the release of the isocyanate groups would lead to premature crosslinking of the coating system. Preferably, the production of the one-component baking systems according to the invention takes place at temperatures between 15 and 100° C.

As binder component b), the one-component baking systems according to the invention contain at least one binder reactive toward isocyanate groups and having on average at least two isocyanate-reactive groups, such as, for example, hydroxyl, mercapto, amino or carboxylic acid groups, per molecule.

Preferably, these binders b) are the usual di- and/or polyhydroxyl compounds known from polyurethane chemistry, such as, for example, polyester polyols, polyether polyols, polycarbonate polyols and/or polyacrylate polyols, or any blends of such polyols.

Suitable polyols b) are, for example, the customary di- and/or polyhydroxyl compounds that are known from polyurethane chemistry, such as, for example, polyester polyols, polyether polyols, polycarbonate polyols and/or polyacrylate polyols, or any desired blends of such polyols.

Suitable polyester polyols b) are, for example, those having a number-average molecular weight, calculable from functionality and hydroxyl number, of 500 to 10 000 g/mol, preferably 800 to 5000 g/mol, particularly preferably 1000 to 3000 g/mol, having a hydroxyl group content of 1% to 21% by weight, preferably 2% to 18% by weight, of the kind producible in a manner known per se by reaction of polyhydric alcohols with deficit amounts of polybasic carboxylic acids, corresponding carboxylic anhydrides, corresponding polycarboxylic esters of lower alcohols, or by reaction with lactones.

Suitable polyhydric alcohols for the production of polyester polyols b) are, for example, 1,2-ethanediol, 1,2- and 1,3-propanediol, the isomeric butanediols, pentanediols, hexanediols, heptanediols and octanediols, 2-ethyl-2-butyl-1,3-propanediol, 2-ethyl-2-isobutyl-1,3-propanediol, 1,10-decanediol, 1,12-dodecanediol, 2,2,4,4-tetramethylcyclobutane-1,3-diol (TMCD), 1,2- and 1,4-cyclohexanediol, 1,4-cyclohexanedimethanol, 1,4-bis(2-hydroxyethoxy)benzene, 2,2-bis(4-hydroxyphenyl)propane (bisphenol A), 2,2-bis(4-hydroxycyclohexyl)propane (perhydrobisphenol), 1,2,3-propanetriol, 1,2,4-butanetriol, 1,1,1-trimethylolethane, 1,2,6-hexanetriol, 1,1,1-trimethylolpropane (TMP), bis(2-hydroxyethyl)hydroquinone, 1,2,4-and 1,3,5-trihydroxycyclohexane, 1,3,5-tris(2-hydroxyethyl)isocyanurate, 3(4),8(9)-bis(hydroxymethyl)tricyclo[5.2.1.02,6]decane, ditrimethylolpropane, 2,2-bis(hydroxymethyl)-1,3-propanediol (pentaerythritol), 2,2,6,6-tetrakis(hydroxymethyl)-4-oxaheptane-1,7-diol (dipentaerythritol), mannitol or sorbitol, low molecular weight ether alcohols, such as diethylene glycol, triethylene glycol, tetraethylene glycol, dipropylene glycol or dibutylene glycol, or low molecular weight ester alcohols, such as hydroxypivalic acid neopentyl glycol ester, or mixtures of at least two such alcohols.

Suitable carboxylic acids and carboxylic acid derivatives for the production of the polyester polyols b) to be used in the one-component baking systems according to the invention are polybasic carboxylic acids, their carboxylic anhydrides and polycarboxylic acid esters of lower alcohols. These are any aromatic, aliphatic or cycloaliphatic, saturated or unsaturated di- and tricarboxylic acids or anhydrides thereof, in particular those having 4 to 18 carbon atoms, preferably having 4 to 10 carbon atoms, such as succinic acid, succinic anhydride, glutaric acid, adipic acid, pimelic acid, suberic acid, azelaic acid, sebacic acid, decanedicarboxylic acid, maleic acid, maleic anhydride, fumaric acid, itaconic acid, itaconic anhydride, hexahydrophthalic acid, hexahydrophthalic anhydride, tetrahydrophthalic acid, phthalic anhydride, isophthalic acid, terephthalic acid, trimellitic acid, tetrahydrophthalic anhydride, dimethyl terephthalate and bisglycol terephthalate, but also dimeric and trimeric fatty acids, which can be used both individually and in the form of any desired mixtures with one another.

Monocarboxylic acids, such as benzoic acid, acetic acid, propionic acid, butyric acid or 2-ethylhexanoic acid, for example, can optionally also be used in a subordinate amount for the production of the polyester polyols b).

Suitable polyester polyols b) for the one-component baking systems according to the invention are also those as may be produced in a manner known per se from lactones and polyhydric alcohols, such as those stated illustratively above, as starter molecules with ring opening. Suitable lactones for the production of these polyester polyols b) are, for example, β-propiolactone, γ-butyrolactone, γ- and δ-valerolactone, ε-caprolactone, 3,5,5- and 3,3,5-trimethylcaprolactone or any mixtures of such lactones.

The production of these lactone polyesters is generally carried out in the presence of catalysts such as Lewis or Brønsted acids, organic tin or titanium compounds at temperatures of 20 to 200° C., preferably 50 to 160° C. Synthesis components suitable for the production of these polyester polyols b) are, for example, the polyhydric alcohols, polybasic carboxylic acids and their derivatives mentioned above as suitable for the production of the polyester polyols b), which can also be used in the form of any desired mixtures.

The production of the polyester polyols b) can be carried out according to methods known per se, such as are described in detail for example in E. Gubbels et al., Polyesters. In: Ullmann's Encyclopedia of Industrial Chemistry, Wiley-VCH Verlag Gmbh & Co. KGaA; 2018. URL: https://doi.org/10.1002/14356007.a21_227.pub2. If necessary, catalytic amounts of standard esterification catalysts, for example acids, bases or transition metal compounds, for example titanium tetrabutoxide, may be used. The esterification reaction is generally conducted within a temperature range from about 80 to 260° C., preferably from 100 to 230° C., until the desired values for the hydroxyl and acid numbers have been attained.

Suitable polyether polyols b) are for example those having an average molecular weight, calculable from functionality and hydroxyl number, of 200 to 6000, preferably 250 to 4000, having a hydroxyl group content of 0.6% to 34% by weight, preferably 1% to 27% by weight, as obtainable in a manner known per se by alkoxylation of suitable starter molecules. Any desired polyhydric alcohols, as described above as suitable for the production of the polyester polyols b), can be used as starter molecules for the production of these polyether polyols.

Suitable alkylene oxides for the alkoxylation reaction are especially ethylene oxide and propylene oxide, which can be used in any order or in a mixture in the alkoxylation reaction. Suitable polycarbonate polyols b) are in particular the reaction products, known per se, of dihydric alcohols, for example those stated by way of example hereinabove in the list of the polyhydric alcohols, with diaryl carbonates, for example diphenyl carbonate, dimethyl carbonate or phosgene. Suitable polycarbonate polyols b) are also those that contain ester groups in addition to carbonate structures. These are, in particular, the polyestercarbonate diols, known per se, as obtainable, for example, according to the teaching of DE-B 1 770 245 by reaction of dihydric alcohols with lactones, such as in particular ε-caprolactone, and subsequent reaction of the resultant polyester diols with diphenyl or dimethyl carbonate. Also suitable polycarbonate polyols b) are those that contain additional ether groups in addition to carbonate structures. These are in particular the polyethercarbonate polyols known per se as obtainable, for example, by the process of EP-A 2 046 861 by catalytic reaction of alkylene oxides (epoxides) and carbon dioxide in the presence of H-functional starter substances.

Suitable polyacrylate polyols b) are, for example, those of an average molecular weight, calculable from functionality and hydroxyl number or determinable by gel permeation chromatography (GPC) of 800 to 50 000, preferably of 1000 to 20 000, having a hydroxyl group content of 0.1% to 12% by weight, preferably 1 to 10, of the kind preparable in a conventional way by copolymerization of olefinically unsaturated monomers containing hydroxyl groups with hydroxyl-group-free olefinic monomers.

Examples of suitable monomers for the production of the polyacrylate polyols b) are vinyl or vinylidene monomers such as styrene, α-methylstyrene, o- or p-chlorostyrene, o-, m- or p-methylstyrene, p-tert-butylstyrene, acrylic acid, acrylonitrile, methacrylonitrile, acrylic and methacryl acid esters of alcohols with up to 18 carbon atoms, such as methyl acrylate, ethyl acrylate, n-propyl acrylate, isopropyl acrylate, n-butyl acrylate, isobutyl acrylate, tert-butyl acrylate, amyl acrylate, hexyl acrylate, 2-ethylhexyl acrylate, isooctyl acrylate, 3,3,5-trimethylhexyl acrylate, stearyl acrylate, lauryl acrylate, cyclopentyl acrylate, cyclohexyl acrylate, 4-tert-butycyclohexyl acrylate, isobornyl acrylate, methyl methacrylate, ethyl methacrylate, n-propyl methacrylate, isopropyl methacrylate, butyl methacrylate, isobutyl methacrylate, tert-butyl methacrylate, amyl methacrylate, hexyl methacrylate, 2-ethylhexyl methacrylate, isooctyl methacrylate, 3,3,5-trimethylhexyl methacrylate, stearyl methacrylate, lauryl methacrylate, cyclopentyl methacrylate, cyclohexyl methacrylate, 4-tert-butycyclohexyl methacrylate, norbornyl methacrylate or isobornyl methacrylate, diesters of fumaric acid, itaconic acid or maleic acid having 4 to 8 carbon atoms, acrylamide, methacrylamide, vinyl esters of alkanemonocarboxylic acids having 2 to 5 carbon atoms, such as vinyl acetate or vinyl propionate, hydroxyalkyl esters of acrylic acid or methacrylic acid having 2 to 5 carbon atoms in the hydroxyalkyl radical; such as 2-hydroxyethyl, 2-hydroxypropyl, 3-hydroxypropyl, 3-hydroxybutyl, 4-hydroxybutyl, trimethylolpropane mono- or pentaerythritol monoacrylate or methacrylate, and also any mixtures of such monomers stated illustratively.

The one-component baking systems according to the invention may optionally contain catalysts c). These are in particular the urethanization catalysts customary in isocyanate chemistry that have already been specified above as suitable for accelerating the reaction of the polyisocyanate component A) with the diol component B) and the amine component C). These catalysts c) are used in the one-component baking systems of the invention as a single substance or in the form of any mixtures with each other in amounts of 0.005% by weight to 5% by weight, preferably of 0.005% by weight to 2% by weight, particularly preferably of 0.005% by weight to 1% by weight, calculated as the sum of all catalysts c) used and based on the total amount of solvent-free blocked polyisocyanate a) and solvent-free binder component b).

The one-component baking systems of the invention may optionally also contain further auxiliaries and adjuvants d). In addition to the above-mentioned antioxidants and light stabilizers for optional use in the process of the invention, these are, for example, the usual plasticizers, leveling aids, rheology additives, slip additives, defoamers, fillers and/or pigments, which are familiar to the skilled person and are used, if at all, in the usual coatings technology amounts. A comprehensive overview of such suitable auxiliaries and adjuvants may be found for example in Bodo Muller, “Additive kompakt”, Vincentz Network GmbH & Co KG (2009).

In the production of the one-component baking systems according to the invention, the polyisocyanate component a) and the binder component b) are preferably used in amounts such that the equivalents ratio of the sum of blocked and unblocked isocyanate groups from a) to isocyanate-reactive groups from b) is from 0.5:1 to 1.5:1, more preferably from 0.7:1 to 1.3:1, especially preferably from 0.8:1 to 1.2:1.

The one-component baking systems according to the invention may optionally contain further compounds reactive toward isocyanate-reactive groups, as an additional crosslinker component. These are, for example, compounds containing epoxy groups and/or amino resins. Amino resins are the condensation products of melamine and formaldehyde, or urea and formaldehyde, which are known in coatings technology.

All conventional melamine-formaldehyde condensates which are not etherified or which have been etherified with saturated monoalcohols having 1 to 4 carbon atoms are suitable. In the case of accompanying use of other crosslinking components, the amount of binder with isocyanate-reactive groups must be adjusted accordingly.

The one-component baking systems according to the invention, thus obtained, may be applied by methods known per se, for example by spraying, brushing, dipping, flooding or with the help of rollers or doctor blades, in one or more coats.

Candidate substrates are any substrates, such as metal, wood, glass, stone, ceramic materials, composites or plastics of any kind, which may optionally also be provided with usual, known primer systems, surfacer systems, basecoat systems and/or clearcoat systems prior to coating.

The curing of the dried films is carried out by baking in temperature ranges from 90 to 160° C., preferably 110 to 140° C. For example, the dry film coat thickness here can be 10 to 120 μm.

The one-component baking systems according to the invention can also be used for continuous strip coating, wherein maximum baking temperatures, known to the skilled person as peak metal temperatures, between 130 and 300° C., preferably 190 to 260° C., and dry film coat thicknesses of, for example, 3 to 40 μm can be achieved.

The features specified as preferred for the process according to the invention are also preferred for the further subject matter of the invention.

The examples which follow serve to illustrate the present invention, but should in no way be understood as imposing any restriction on the scope of protection.

### EXAMPLES

All percentages are based on the weight, unless otherwise noted.

NCO contents were determined titrimetrically in accordance with DIN EN ISO 11909:2007-05. The course of the blocking reaction and the NCO-freedom of the blocked polyisocyanates were followed by the decrease or absence of the isocyanate band (around 2270 cm⁻¹) in the IR spectrum.

All viscosity measurements were performed with a Physica MCR 51 rheometer from Anton Paar Germany GmbH (DE) in accordance with DIN EN ISO 3219:1994-10 at a shear rate of 250 s⁻¹.

The residual monomer contents were measured in accordance with DIN EN ISO 10283:2007-11 by gas chromatography with an internal standard.

The platinum-cobalt color number was measured by spectrophotometry according to DIN EN ISO 6271-2:2005-03 with a LICO 400 spectrophotometer from Lange, Germany.

The contents (mol %) of the uretdione, possibly isocyanurate and/or iminooxadiazinedione structures present in the polyisocyanates A) were calculated from the integrals of proton-decoupled 13C-NMR spectra (recorded on a Bruker DPX-400 instrument) and are based in each case on the sum of uretdione, isocyanurate, allophanate, biuret, iminooxadiazinedione and/or oxadiazinetrione structures present. In the case of HDI polyisocyanates dissolved in CDCl3, the individual structural elements exhibit the following chemical shifts (in ppm): uretdione: 157.1; isocyanurate: 148.4; iminooxadiazinedione: 147.8, 144.3 and 135.3; allophanate: 155.7 and 153.8, biuret: 155.5; urethane: 156.3; oxadiazinetrione: 147.8 and 143.9.

### Starting Compounds

### Polyisocyanates A)

### Starting Polyisocyanate A1)

Polyisocyanate produced by catalytic trimerization of HDI based on Example 11 of EP-A 330 966 with the exception that the reaction was terminated by addition of dibutyl phosphate at an NCO content of the crude mixture of 40%. Subsequently, unconverted HDI was removed by thin-film distillation at a temperature of 130° C. and a pressure of 0.2 mbar.

The product had the following characteristics and composition:
NCO content: 21.8%
Monomeric HDI: 0.06%
Viscosity (23° C.): 3020 mPas
Color index (Hazen): 8
Uretdione structures: 0.8 mol %
Isocyanurate structures: 90.2 mol %
Iminooxadiazinedione structures: 3.8 mol %
Allophanate structures: 5.2 mol %

### Starting Polyisocyanate A2)

Polyisocyanate produced on the basis of comparative example 2a of WO 2018/153801 by trimerization of HDI using a 20% solution of 5-azonia-spiro[4.5]decanium hydrogendifluoride in 2-ethylhexanol as catalyst, reaction termination at an NCO content of the crude mixture of 44.8% by addition of an amount equivalent to the catalyst amount of a 70% solution of dodecylbenzenesulfonic acid in isopropanol and subsequent separation of the unconverted HDI by thin-film distillation at a temperature of 130° C. and a pressure of 0.2 mbar.

The product had the following characteristics and composition:
NCO content: 23.5%
Monomeric HDI: 0.11%
Viscosity (23° C.): 720 mPas
Color index (Hazen): 49
Uretdione structures: 4.9 mol %
Isocyanurate structures: 46.7 mol %
Iminooxadiazinedione structures: 48.4 mol %

### Starting Polyisocyanate A3)

PDI polyisocyanate comprising isocyanurate groups, produced by catalytic trimerization of PDI by the method described in WO 2016/146579 for the polyisocyanate component A2).

The reaction was deactivated at an NCO content of the crude mixture of 36.7% by addition of an equimolar amount of dibutyl phosphate, based on the amount of catalyst used, and further stirring for 30 minutes at 80° C. Subsequently, unconverted PDI was removed by thin-film distillation at a temperature of 140° C. and a pressure of 0.5 mbar.
NCO content: 21.8%
Monomeric PDI: 0.09%
Viscosity (23° C.): 9850 mPas
Color index (Hazen): 34
Uretdione structures: 4.9 mol %
Isocyanurate structures: 46.7 mol %
Iminooxadiazinedione structures: 48.4 mol %

### Example 1 (Comparative)

289 g (1.50 eq) of the starting polyisocyanate A1) containing isocyanurate structures were introduced at a temperature of 50° C. with stirring and under dry nitrogen and admixed with 151.8 g (1.50 eq) of diisopropylamine over a period of 2 hours. After amine addition had ended, the reaction mixture was diluted with 188.9 g of 1-methoxyprop-2-yl acetate (MPA) and stirred for another hour at 50° C. until the isocyanate groups were fully reacted (IR checking, absence of the isocyanate band at around 2270 cm⁻¹). A colorless solution of an amine-blocked HDI polyisocyanurate polyisocyanate with the following characteristics was present:
NCO content (blocked): 10.0%
NCO content (free): 0.0%
Solids content: 70% by weight
Viscosity (23° C.): 8050 mPas

After cooling to room temperature, the solution became turbid after one day and was fully crystallized after five days.

### Example 2 (According to the Invention)

770 g (4.00 eq) of the starting polyisocyanate A1) containing isocyanurate structures were introduced at a temperature of 70° C. with stirring and under dry nitrogen, admixed over 15 min with 58 g (0.73 eq) of 2-butyl-2-ethyl-1,3-propanediol (BEPD), corresponding to an amount of 7.0% by weight based on the total amount of polyisocyanate and branched diol, and stirring was continued until the 16.9% NCO content corresponding to complete urethanization was reached. The reaction mixture was cooled to 50° C. and 337 g (3.34 eq) of diisopropylamine were added over a period of 4 hours. To reduce the significantly increasing viscosity during the blocking reaction, a total of 250 g of 1-methoxyprop-2-yl acetate (MPA) were added over the overall metering time, in several individual portions. After amine addition had ended, the reaction mixture was stirred for another hour at 50° C. until the isocyanate groups were fully reacted (IR checking). The product was then diluted with a further 250 g of isobutanol. This gave a colorless clear solution of an amine-blocked HDI polyisocyanurate polyisocyanate according to the invention with the following characteristics:
NCO content (blocked): 8.3%
NCO content (free): 0.0%
Solids content: 70% by weight
Viscosity (23° C.): 13 700 mPas

After 12 weeks of storage at room temperature, the solution was still completely clear. No instances of turbidity, solids precipitation or crystallization were observed.

### Examples 3 to 11 (According to the Invention and Comparative)

According to the process described in Example 2, polyisocyanates blocked by urethanization with different branched diols and diisopropylamine were produced, starting from different polyisocyanates, with the entire amount of solvent having been introduced in each case together with the polyisocyanate component even before the commencement of the reaction.

The following table shows the compositions in % by weight, characteristic data and storage stability of the resulting products, after 4 weeks of storage at room temperature.

| | | | | 5 | | | 8 | | 10 | |
|---|---|---|---|---|---|---|---|---|---|---|
| Example | | 3 | 4 | (comparative) | 6 | 7 | (comparative) | 9 | (comparative) | 11 |
| Polyisocyanate | A1) | 274.5 | 274.5 | 283.2 | 274.5 | 264.0 | — | — | — | — |
| component | A2) | — | — | — | — | — | 277.0 | 277.0 | — | — |
| | A3) | — | — | — | — | — | — | — | 289.0 | 289.0 |
| Diol component | BEPD | 14.4 | — | — | 8.5 | 36.0 | — | — | — | 15.2 |
| B) | TMPD | — | 14.4 | 5.8 | — | — | — | — | — | — |
| | 2-EH | — | — | — | — | — | — | 20.8 | — | — |
| Proportion of B) | [% by | 5 | 5 | 2 | 3 | 12 | 0 | 7 | 0 | 5 |
| | weight] | | | | | | | | | |
| Diisopropylamine | | 126.0 | 124.2 | 140.7 | 133.1 | 92.9 | 156.6 | 127.8 | 151.5 | 132.3 |
| MPA | | 177.8 | 177.2 | 184.2 | 277.4 | 393.0 | 185.8 | 182.4 | 293.7 | 291.0 |
| NCO content | [% by | 8.8 | 8.7 | 9.5 | 8.0 | 4.9 | 10.5 | 8.7 | 8.6 | 7.6 |
| (blocked) | weight] | | | | | | | | | |
| NCO content | [% by | 0.0 | 0.0 | 0.0 | 0.0 | 0.0 | 0.0 | 0.0 | 0.0 | 0.0 |
| (free) | weight] | | | | | | | | | |
| Solids content | [% by | 70 | 70 | 70 | 60 | 50 | 70 | 70 | 60 | 60 |
| | weight] | | | | | | | | | |
| Viscosity | [mPas] | 15 000 | 10 700 | 7820 | 4570 | 47 900 | 2060 | 4600 | 16 700 | 23 100 |

| | | | | | | | | | |
|---|---|---|---|---|---|---|---|---|---|
| Appearance after | clear | clear | clear | clear | clear | clear | clear | clear | clear |
| production | | | | | | | | | |
| incipient turbidity after | — | — | 10 d | — | — | 1 d | — | 1 d | — |
| Appearance after 4 weeks | clear | clear | solid | clear | clear | solid | clear | solid | clear |
| at RT | | | | | | | | | |

Examples 2, 3, 4, 6, 7, 9 and 11 according to the invention show that polyisocyanates containing isocyanurate and iminooxadiazinedione structures and having been partially urethanized with more than 2% by weight of branched aliphatic diols, based on the total amount of polyisocyanate and diol, can be reacted with secondary amines such as diisopropylamine to form clear blocked polyisocyanate crosslinkers which over a period of 4 weeks are completely storage-stable and show no tendency to crystallize.

By contrast, the blocked polyisocyanates of Comparative Examples 1, 5, 8 and 10, which were produced without or using only 2% by weight of a branched diol, become turbid at room temperature after just a short time and are completely crystallized after 4 weeks.

1. A process for producing a blocked polyisocyanate, comprising a reaction of
A) at least one polyisocyanate component comprising isocyanurate or iminooxadiazinedione structures;
B) at least one branched aliphatic diol, and
C) at least one secondary amine having aliphatic, cycloaliphatic or araliphatic substituents,
wherein component B) is present in an amount of more than 2% by weight, based on the total amount of components A) and B),
wherein component C) is present in an amount which corresponds to at least 95 mol % of the isocyanate groups arithmetically still present after the reaction of components A) and B), and
wherein polyisocyanate component A) comprises polyisocyanates produced by modification of simple linear aliphatic, cycloaliphatic, araliphatic or aromatic diisocyanates where >70 equivalent %, based on the NCO content, of linear aliphatic diisocyanates have been used for the modification.

2. The process of claim 1, wherein polyisocyanates produced by modification of simple linear aliphatic, cycloaliphatic, araliphatic or aromatic diisocyanates and having at least isocyanurate or iminooxadiazinedione structures are used as polyisocyanate component A), where >80 equivalent % based on the NCO content have been used for the modification.

3. The process of claim 1 wherein polyisocyanate component A comprises 1,6-diisocyanatohexane or 1,5-diisocyanatopentane, with isocyanurate or iminooxadiazinedione structures.

4. The process of claim 1, wherein polyisocyanate component A) comprises polyisocyanates having isocyanurate structures and an average NCO functionality of 2.3 to 5.0 and a content of isocyanate groups of 6.0% to 26.0% by weight.

5. The process of claim 1, wherein the at least one branched aliphatic diol has 3 to 36 carbon atoms.

6. The process of claim 1, wherein the at least one branched aliphatic diol is selected from the group consisting of 2-methyl-1,3-propanediol, 2,2-dimethyl-1,3-propanediol, 2-butyl-2-ethyl-1,3-propanediol, 2,2-dibutyl-1,3-propanediol, 2,2,4-trimethyl-1,5-pentanediol and 2,2,4-trimethylhexanediol, 2,4,4-trimethylhexanediol and mixtures of such alcohols.

7. The process of claim 1, wherein component B) is present in an amount of 3% to 20% by weight, based on the total amount of components A) and B).

8. The process of claim 1, wherein the at least one secondary amine of component C) has the general formula (I) 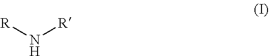
in which R and R′ independently of each other are identical or different radicals which denote saturated or unsaturated, linear or branched, aliphatic, cycloaliphatic or araliphatic organic radicals having 1 to 18 carbon atoms, which are substituted or unsubstituted or have oxygen atoms in the chain, where R and R′ also in combination with each other together with the nitrogen atom and optionally with further oxygen atoms may form heterocyclic rings having 5 to 8 ring members, which may optionally be further substituted.

9. The process of claim 1, wherein the at least one secondary amine of component C) has the general formula (I) 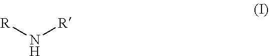
in which R and R′ independently of each other denote identical or different saturated, linear or branched, aliphatic radicals having 1 to 6 carbon atoms or cycloaliphatic hydrocarbon radicals having 6 to 9 carbon atoms, where R and R′ optionally also in combination with each other together with the nitrogen atom and optionally with a further oxygen atom may form heterocyclic rings having 5 to 6 ring members, which may optionally be further substituted.

10. The process of claim 1, wherein the at least one secondary amine of component C) is diisopropylamine, dicyclohexylamine, N-tert-butylbenzylamine or any mixtures of these amines.

11. The process of claim 1, wherein the at least one secondary amine of component C) is present in an amount which corresponds to at least 100 mol % of the isocyanate groups arithmetically still present after the reaction of components A) and B).

12. The process of claim 1, wherein the polyisocyanate component A) is reacted with the diol component B) and the amine component C), optionally in the presence of suitable solvents, at a temperature between 40 to 80° C., in any order.

13. (canceled)

14. A one-component baking system comprising
a) at least one blocked polyisocyanate produced by the process of claim 1,
b) at least one binder reactive toward isocyanate groups and having on average at least two isocyanate-reactive groups per molecule,
c) optionally catalysts, and
d) optionally solvents and/or optionally auxiliaries and adjuvants.

15. A substrate at least partially coated with at least one cured one-component baking system of claim 14.

16. The process of claim 1, wherein polyisocyanates produced by modification of simple linear aliphatic, cycloaliphatic, araliphatic and/or aromatic diisocyanates and having at least isocyanurate and/or iminooxadiazinedione structures are used as polyisocyanate component A), where >90 equivalent % based on the NCO content have been used for the modification.

17. The process of claim 1, wherein polyisocyanates produced by modification of simple linear aliphatic, cycloaliphatic, araliphatic and/or aromatic diisocyanates and having at least isocyanurate and/or iminooxadiazinedione structures are used as polyisocyanate component A), where solely linear aliphatic diisocyanates have been used for the modification.

18. The process of claim 1, wherein polyisocyanate component A) comprises polyisocyanates having isocyanurate structures and an average NCO functionality of 2.5 to 4.5, and a content of isocyanate groups of 10.0% to 24.0% by weight.

19. The process of claim 1, wherein the at least one branched aliphatic diol has 4 to 12 carbon atoms.

20. The process of claim 1, wherein component B) is present in an amount of 4% to 15% by weight, based on the total amount of components A) and B).

21. The process of claim 1, wherein component B) is present in an amount of 5% to 12% by weight, based on the total amount of components A) and B).
